(19) United States
(12) Patent Application Publication
(10) Pub. No.: US 2010/0262451 A1
(43) Pub. Date: Oct. 14, 2010

(54) Simplified Approach for Service Composition and Orchestration

(75) Inventors: Ali Bahrami, Sammamish, WA (US); Jun Yuan, Sammamish, WA (US)

Correspondence Address: DUKE W. YEE, YEE & ASSOCIATES, P.C., P.O. BOX 802333, DALLAS, TX, 75380, US

(73) Assignee: THE BOEING COMPANY, Chicago, IL (US)

(21) Appl. No.: 12/423,493

(22) Filed: Apr. 14, 2009

(51) Int. Cl. G06Q 10/00; G06F 17/30

(52) U.S. Cl. 705/8; 707/E17.044

(57) ABSTRACT

The different advantageous embodiments provide a method, apparatus, and computer program product for improved workflow management. A workflow model is executed. The workflow model may include a number of worklets. Each worklet in the number of worklets may have a number of associated assistlets. A determination is made as to whether a number of associated assistelets for a first worklet in the number of worklets execute during execution of the workflow model. In response to a determination that the number of associated assistlets for the first worklet execute, the number of associated assistlets for the first worklet are executed.

### BACKGROUND INFORMATION

1. Field

The present disclosure relates generally to workflow management and more specifically to an improved method for simplified service composition and orchestration that enables adaptive workflow execution. Still more particularly, the present disclosure relates to workflow management processes used during the life cycle of an aircraft.

2. Background

A number of different activities may make up a business process. Separate services or processes may be brought together in a consistent manner to provide a higher value service or process, such as a business process. Services may represent existing information technology assets. Services may include web services, which are software services that support inter-machine interactions over the internet. Processes may define the overall functioning of the business. Business processes are on the higher level of orchestration, where as services tend to be more fine grained, are on the lower level of orchestration and implement the business processes.

Automating a sequence of services or processes results in a workflow. Workflow management systems may create, define, and execute a workflow. For example, workflow management systems may control the way in which the sequence is combined. Service orchestration refers to the combination of workflow management with services.

One example of service orchestration is seen during the lifecycle of an aircraft. Separate services or processes may be brought together during aircraft manufacturing and maintenance. For example, an aircraft maintenance process may include steps for identifying a component failure, scheduling maintenance for an aircraft, ordering the requisite parts and/or tools to use during the maintenance process, and performing maintenance on the aircraft.

Traditionally, workflow management systems have been applied to support task coordination in well-defined, structured, and frequently used processes to achieve quantitative benefits such as performance improvement or cost reduction. Workflow management requires a high level of integration with other information systems. The success of the workflow project highly depends on the extent to which the other information systems can be applied and the workflow management system can support each of the different processes of the workflow.

Ad hoc or unstructured processes refer to processes for which the relevant information is either difficult to determine or can only be determined during runtime. From this point of view, the structure of the process has to be estimated in context of a special organizational and technical environment, or in context of a virtual environment, as offered by a typical workflow management system. However, when the estimation is different from the real-time situation, the whole workflow model may not work at all. This type of process depends on the time when information will be available and the way or circumstances in which the information can be gathered. The ability of a system to perform unstructured workflow depends on the expressiveness of the workflow model and the power of the workflow enactment. These two elements represent two main technological barriers to current system implementation with respect to adaptability.

Accordingly, there is a need for a method and apparatus, which takes into account one or more of the issues discussed above as well as possibly other issues.

### SUMMARY

An embodiment of the present disclosure provides a method, apparatus, and computer program product for improved workflow management. A workflow model is executed. The workflow model may include a number of worklets. Each worklet in the number of worklets may have a number of associated assistlets. A determination is made as to whether a number of associated assistelets for a first worklet in the number of worklets execute during execution of the workflow model. In response to a determination that the number of associated assistlets for the first worklet execute, the number of associated assistlets for the first worklet are executed.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the advantageous embodiments are set forth in the appended claims. The advantageous embodiments, however, as well as a preferred mode of use, further objectives and advantages thereof, will best be understood by reference to the following detailed description of an advantageous embodiment of the present disclosure when read in conjunction with the accompanying drawings, wherein:

FIG. 1 is a diagram illustrating an aircraft manufacturing and service method in accordance with an advantageous embodiment;

FIG. 2 is a diagram of an aircraft in which an advantageous embodiment may be implemented;

FIG. 3 is a diagram of a workflow environment in accordance with an advantageous embodiment;

FIG. 4 is a diagram of a data processing system in accordance with an advantageous embodiment;

FIG. 5 is a diagram of a workflow in accordance with an advantageous embodiment;

FIG. 6 is a diagram of a transition logic interface in accordance with an advantageous embodiment;

FIG. 7 is a diagram of a repository in accordance with an advantageous embodiment;

FIG. 8 is a flowchart illustrating a process for adaptive workflow management in accordance with an advantageous embodiment; and

FIG. 9 is a flowchart illustrating a process for automated workflow modeling in accordance with an advantageous embodiment.

### DETAILED DESCRIPTION

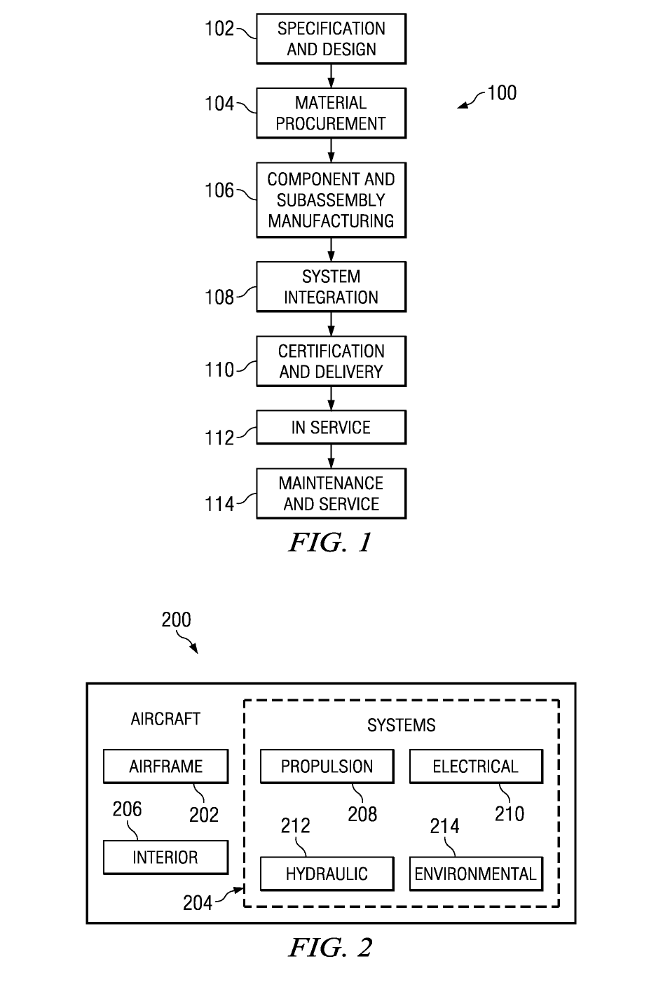

Referring more particularly to the drawings, embodiments of the disclosure may be described in the context of the aircraft manufacturing and service method 100 as shown in FIG. 1 and aircraft 200 as shown in FIG. 2. Turning first to FIG. 1, a diagram illustrating an aircraft manufacturing and service method is depicted in accordance with an advantageous embodiment. During pre-production, exemplary aircraft manufacturing and service method 100 may include specification and design 102 of aircraft 200 in FIG. 2 and material procurement 104.

During production, component and subassembly manufacturing 106 and system integration 108 of aircraft 200 in FIG. 2 takes place. Thereafter, aircraft 200 in FIG. 2 may go through certification and delivery 110 in order to be placed in service 112. While in service by a customer, aircraft 200 in FIG. 2 is scheduled for routine maintenance and service 114, which may include modification, reconfiguration, refurbishment, and other maintenance or service.

Each of the processes of aircraft manufacturing and service method 100 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of venders, subcontractors, and suppliers; and an operator may be an airline, leasing company, military entity, service organization, and so on.

Each of the processes of aircraft manufacturing and service method 100 may include a number of tasks. The number of tasks may be executed to accomplish the process. For example, if the process is routine maintenance and service 114, the number of tasks may include, without limitation, receiving a part assembly failure notification, determining the specifics of the failure, ordering parts to replace the part in failure, predicting delay/cancellation/costs associated with the part failure, ordering maintenance on the aircraft with the part failure, and performing the maintenance ordered. The number of tasks represents real world activities that may be carried out to perform a process. A process may be performed by an operator, such as a human, a device, such as a data processing system, a computer controlled machine, and/or any other suitable operator. Other examples of real world activities that may be tasks may include, without limitation, component assembly, component inspection, assembly inspection, scheduling routine maintenance, and the like.

The illustration of aircraft manufacturing and service method 100 in FIG. 1 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

Although an aerospace example is shown, different advantageous embodiments may be applied to other industries, such as the automotive industry.

With reference now to FIG. 2, a diagram of an aircraft is depicted in which an advantageous embodiment may be implemented. In this example, aircraft 200 is produced by aircraft manufacturing and service method 100 in FIG. 1 and may include airframe 202 with a plurality of systems 204 and interior 206. Examples of systems 204 include one or more of propulsion system 208, electrical system 210, hydraulic system 212, and environmental system 214.

Apparatus and methods embodied herein may be employed during any one or more of the stages of aircraft manufacturing and service method 100 in FIG. 1. For example, materials procured during material procurement 104 in FIG. 1 may be procured while aircraft 200 is in maintenance and service 114 in FIG. 1.

Also, one or more apparatus embodiments, method embodiments, or a combination thereof may be utilized during production stages, such as component and subassembly manufacturing 106 and system integration 108 in FIG. 1, for example, without limitation, by substantially expediting the assembly of or reducing the cost of aircraft 200. Similarly, one or more of apparatus embodiments, method embodiments, or a combination thereof may be utilized while aircraft 200 is in service 112 or during maintenance and service 114 in FIG. 1.

For example, different advantageous embodiments may be employed to manage a workflow for a maintenance session during maintenance and service 114. Advantageous embodiments also may be implemented to execute and manage a workflow project during component and subassembly manufacturing 106, system integration 108, and/or maintenance and service 114.

The different advantageous embodiments recognize and take into account a number of different considerations. For example, one or more of the advantageous embodiments recognize and take into account that currently used systems for service orchestration do not offer sufficient flexibility for adaptability. Mapping high level process models to low level services or processes is not a simple task and it is dependent upon how the individual low level processes are described. Additionally, it is not always possible to predict in advance all of the parameters that may be important for the high level process. It may not be possible to specify all the process details associated with a complex process at the outset. The initial workflow model may represent a high level view of the process, which includes some of the sub-processes. Gradually, some of these sub-processes may be refined as the stakeholders obtain more experience and knowledge of a particular process. A change may also impose a new requirement that impacts the process definition.

The different advantageous embodiments further recognize that relevant information to a process may only be determined during runtime. Current methods require an estimation of the structure of the process in the context of a specific environment. This estimation depends upon when information will be available and the way or circumstances in which information can be gathered.

Thus, the different advantageous embodiments provide a method, apparatus, and computer program product for improved workflow management. A first workflow model is selected from a number of workflow models. The first workflow model may include a number of worklets and the number of worklets may include a number of services. A first service in the number of services is identified that will not execute. The first service is capable of performing a first task. A second service is identified that is capable of performing the first task. The first service in the first workflow model is replaced with the second service.

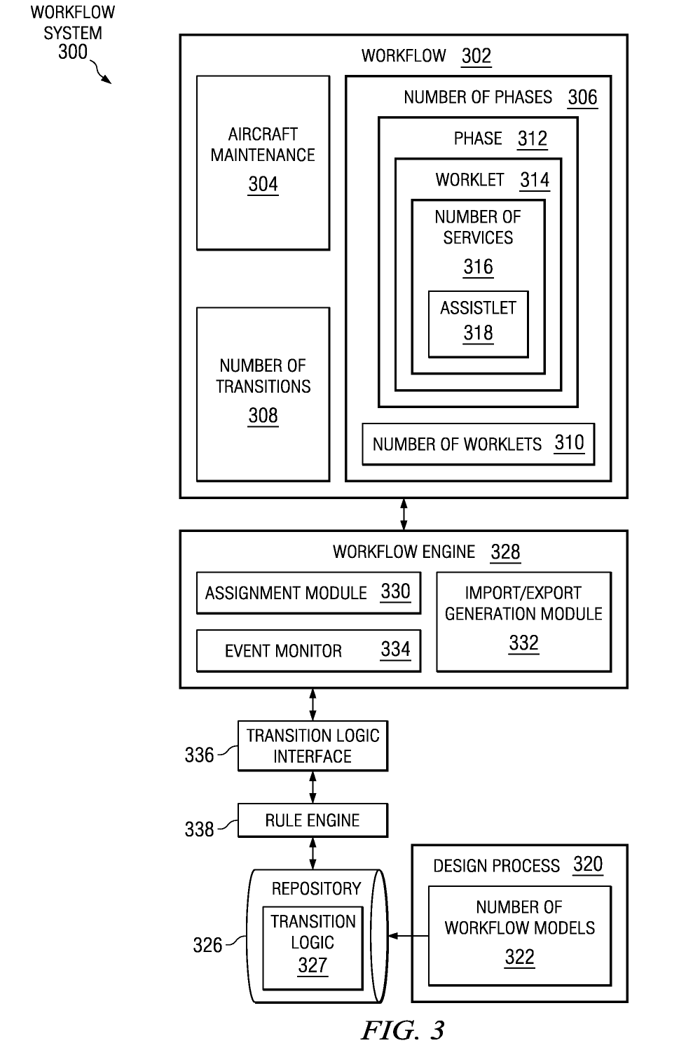

With reference now to FIG. 3, a diagram of a workflow environment is depicted in accordance with an advantageous embodiment. Workflow system 300 may be implemented in an aircraft manufacturing and service method, for example, such as component and subassembly manufacturing 106, maintenance and service 114, and/or any other applicable service method.

Workflow system 300 may be implemented in a design environment or a production environment. In one advantageous embodiment, workflow system 300 may include workflow 302. Workflow 302 may be one example of a workflow project or sequence of activities that may be performed by workflow system 300. For example, in the illustrative example of implementation during an aircraft service method, workflow 302 may be aircraft maintenance

Workflow 302 may include a number of phases 306. As used herein, a number refers to one or more phases. Phases refer to a number of operations that are performed to obtain a result. For example, one phase may be an operation performed to manufacture an aircraft component, while another phase may be an operation performed to install the aircraft component, resulting in a completed aircraft manufacturing operation. Number of phases 306 may include number of worklets 310. A worklet is a collection of web services, or assistlets, that perform a phase of work. An assistlet, unlike a web service that is stateless, has a state. For example, the associated state may be a state such as, without limitation, “running,” “paused,” “stopped,” and/or any other suitable state. A web service may be any software service that supports inter-machine interactions over the internet, for example. An assistlet is capable of accomplishing a specific task in the phase of work defined by the worklet.

Each phase in the number of phases that make up workflow 302 may be comprised of a worklet. For example, number of phases 306 may include phase 312. Phase 312 may be comprised of worklet 314. Worklet 314 is one example of an individual worklet in number of worklets 310. Each worklet in number of worklets 310 may further be comprised of a number of web services or assistlets. For example, worklet 314 includes number of services 316. An example of one service within number of services 316 may be assistlet 318. As used herein, a number refers to one or more services or assistlets. In an illustrative example, phase 312 may be comprised of worklet 314, and worklet 314 may include assistlet 318.

One or more transitions from number of transitions 308 may be associated with phase 312. A transition is a decision gate for each phase in a workflow, such as phase 312 in workflow 302. At each transition, a decision will be made to move to a subsequent phase or stay at the current phase. Number of transitions 308 may be driven by transition logic generated by rule engine 338 and/or located in repository 326.

For each phase of work, or worklet, there is at least one transition. A start worklet will have one out-transition. An end worklet will have one in-transition. Any other worklet that is not a start or end worklet will have two transitions, both an in-transition and an out-transition. For each workflow model, there will be only one start worklet and one end worklet. Every worklet in a workflow model is reachable from the start worklet. In other words, there is a path from the start worklet to every other worklet in the workflow model. The end worklet has no successor, and is reachable from every other worklet in the workflow model.

A worklet is programmed in a modeling language as an object configured to quantify relevant work that is accomplished by a user or system. The worklet will be associated with the tools used to accomplish the work, the input data, and the artifacts or output data created as a result of the work. The definition of any worklet is based upon the phase of work described and is independent of underlying work processes used to accomplish that phase of work. A worklet object includes a boundary, or boundary condition, that is associated with a transition object. The transition object includes a decision gate admitting the accomplishment of the phase of work within the boundary. When the boundary condition is satisfied, the transition object allows the next worklet, for the next phase of work, to commence. When the boundary condition is not satisfied, the process will continue work in the current worklet for the current phase of work.

The underlying work processes used to accomplish the phase of work include, but are not limited to, assistlets associated with an individual worklet. An assistlet is a specialized web service, an executable program component, which is configured to perform a defined task. Examples of a defined task may include tasks such as, without limitation, “open new document template,” “save document,” “open email editor,” and “attached document to electronic message,” for example. Elements of a phase of work are accomplished by assistlets. Assistlets may be configured to perform repeatable sub-processes of a phase of work.

There are two types of assistlets: application assistlets and system assistlets. Application assistlets are processes that perform application logic. Some examples of application assistlets include, but are not limited to, processes such as link analysis, aggregation filter, appointment monitoring, data source monitor, data transformation, electronic messages, information gofer, semantic query, information filter, system state monitor, sensor, and the like. A sensor assistlet may detect the context, time, location, and the like, for example. System assistlets are processes that assist in communications or control of other processes. For example, system assistlets may perform iteration or other control blocks such as “and,” “or,” and the like. Some examples of system assistlets may include, but are not limited to, rule engine, set state, extensible markup language-based publish and subscribe, and the like. System assistlets are utilities for pulling information that may be used to enable replacement of one web service, or assistlet, for another web service or assistlet, providing adaptability to workflow system 300.

Actions may be assigned to individual assistlets that can change the states of the assistlets. Actions may include, for example, “start” or “stop”. In an illustrative example, if an action such as “start” is assigned to an assistlet, the state of the assistlet may be changed to “running” in this example. These actions may be assigned during design-time by a user, or during run-time through event-based rules. For example, and event may be, without limitation, “data not available,” “service down,” or “service failure.” Event-based rules may include a rule such as, for example, if “data not available” then assign action “stop” for the assistlet returning the value “data not available” and assign action “search repository” to a system assistlet. Assigning action “stop” changes the state of the assistlet from “running” to “stopped.” A “search repository” action may include detailed instructions for locating an assistlet in the repository that can do same task or function as the assistlet with the state “stopped.”

A practical distinction between worklets and assistlets is that worklets are defined phases of work and are independent of the actual means that cause the phase of work to be accomplished. assistlets are the individual executable program components that are currently selected to accomplish the worklet. As there may be several distinct and suitable means including the assistlets that will accomplish the worklet, programmers select a most suitable ordered series of assistlets and associate that most suitable ordered series of assistlets with the worklet to allow accomplishment of the worklet. When a more suitable ordered series of assistlets becomes known or is configured during run-time, workflow engine 328 may associate the new, more suitable series or assistlets with the worklet during run-time in lieu of the earlier suitable ordered series of assistlets assigned at design-time. In other words, workflow engine 328 may dynamically replace a number of services and/or a number of assistlets and/or a number of worklets during a runtime environment for workflow 302.

Workflow 302 may be created during design time using design process 320. Design process 320 may develop number of workflow models 322 using a number of services, assistlets, and worklets available in repository 326. Design process 320 may then store the number of workflow models 322 in respository 326, where they can be accessed during runtime by workflow engine 328.

Workflow engine 328 manages workflow 302. Workflow engine 328 may include assignment module 330, import/export generation module 332, and event monitor 334. Assignment module 330 assigns one or more services, or assistlets, to a worklet. For example, during run-time assignment module 330 may search repository 326 for assistlet 318 and replace an assistlet originally associated with worklet 314 with assistlet 318, assigning assistlet 318 to worklet 314.

Import/export generation module 332 loads existing business process execution language (BPEL) based definitions from other tools in the network data processing system environment. Import/export generation module 332 describes user defined processes, such as workflow 302, with standard BPEL language so that the exports can be imported into other tools for better interoperability.

Workflow engine 328 is able to generate business process execution language (BPEL), which can be executed by any business process execution language engine, such as, without limitation, ActiveBPEL in an Eclipse environment for example. Eclipse is a multi-language software development platform comprising an integrated development environment and a plug-in system to extend it. It is written primarily in Java and is used to develop applications in this language and, by means of the various plug-ins, in other languages as well, such as C/C++, Cobol, Python, Perl, PHP and more.

Business process execution language may be used to describe executable business processes and abstract processes. Abstract processes are used to create behavioral specifications consisting of the mutually visible messages exchanged between transacting parties executing a business protocol. Business process execution language allows for abstracting the collaboration and sequencing logic out of platform-dependent code and into a formal process definition based on Extensible Markup Language (XML), Web Services Description Language (WSDL), and Extensible Markup Language Schema (XML Schema). Business process execution language files may describe a workflow, such as workflow 302, by stating whom the participants are, what services the participants must implement in order to belong to the workflow, and the control flow of the workflow process. The business process execution language process model may be built as Web Services Description Language (WSDL) port types. In other words, a business process execution language description may describe the choreography of services and a set of messages among the services. This allows business process execution language to be compositionally complete, which means that the composition of processes, or assistlets for example, to accomplish the work may be exposed as a single web service eligible to participate in other compositions.

Event monitor 334 monitors the execution and adaptation of workflow 302 during run-time using a publish/subscribe method. Event monitor 334 identifies exceptions or potential exceptions by means of watching various external events. Event monitor 334 may subscribe to certain events, such as a service being unavailable during runtime, for example. In this illustrative example, during execution of workflow 302, workflow engine 318 may receive an indication that one or more services, or assistlets, in one or more of the worklets for workflow 302 cannot be executed, due to data unavailability for example. Event monitor 334 may detect this exception and trigger workflow engine 328 to search respository 326 and look for an alternative assistlet using rule engine 338 and transition logic interface 336. The replacement service or services may be associated with the current workflow project or a given circumstance, for example, and identified using process interchangeability rules located in repository 326. In one illustrative embodiment, the replacement service, or assistlet, is assigned to the worklet in the currently executing workflow model, such as worklet 314 in workflow 302. In another illustrative embodiment, the replacement service, or assistlet, may be assigned to a different worklet, and this different worklet will be selected to take the place of the worklet in the currently executing workflow model. This adaptation during runtime through the replacement of one worklet for another worklet, or the replacement of one or more services of a worklet for one or more other services, provides adaptability to workflow system 300. This adaptation is achieved through use of a rule-based system that provides rules for when and how one worklet may be replaced with another worklet, or one service may be replaced by another service.

Transition logic interface 336 is a graphical user interface that enables users to map services, or assistlets for example, to existing worklets. Transition logic interface 336 displays transition logic 327. Transision logic 327 represents each web service or assistlet, as a proposition. The proposition may take a form, such as, for example, “web service A has a value of Y.” Transition logic 327 may be stored remotely from transition logic interface 336, such as in repository 326, or may be stored locally at transition logic interface 336.

Transition logic 327 allows associations of one set of web services, or assistlets, to another set of web services based on either the return value for each web service or external rules. Transition logic 327 supports conjunctive and disjunctive normal form, such as, for example, AND, NOT, and OR. Transition logic interface 336 may also access external rules using rule engine 338, and/or stored in repository 326.

Rule engine 338 may be used during the transition between phases of work or may be used as a service or assistlet itself. Rule engine 338 may be, for example, without limitation, a DROOLS engine. DROOLS is a business rule management system (BRMS) with a forward chaining inference based rules engine, also known as a production rule system, using an enhanced implementation of the Rete algorithm.

Repository 326 includes workflow models, processes, transition objects, process interchangeability rules, and transition logic rules, such as transition logic 327. This data is persistently stored in repository 326 and indexed with some basic characteristics to enable fast searching and retrieving purposes, such as metadata for example. Repository 326 may be used during design time to retrieve the most appropriate worklet or assistlet for a workflow model available at design time. Repository 326 may be used during runtime by workflow engine 328 to autonomously retrieve a more appropriate worklet or assistlet during execution of the workflow model. Repository 326 may also manage the state of the individual web services, or assistlets, during runtime.

No explicit loops or branches are present in a workflow model in these illustrative examples. For each workflow model there will be only one Start worklet. For each worklet there is one In-Transition and one Out-Transition, with an exception for Start worklet and End worklet. Every worklet in the graph is reachable from the Start worklet. In other words, only one, path is present from the Start worklet to every other worklet in the graph. End worklet has no successor. End worklet is reachable from all worklets in the graph. A path is present from every worklet to the End worklet. Worklet has 0 to n assistlets. Users do not need to model the loops or branches. Assistlets may interact with each others and create loops or branches, but that is dependent upon the developer of the assistlets or the transition rules to define these interactions that may result in loops. This relieves regular users from the need to explicitly define loops.

The illustration of workflow system 300 in FIG. 3 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

Although an aerospace example is shown, different advantageous embodiments may be applied to other industries, such as the automotive industry.

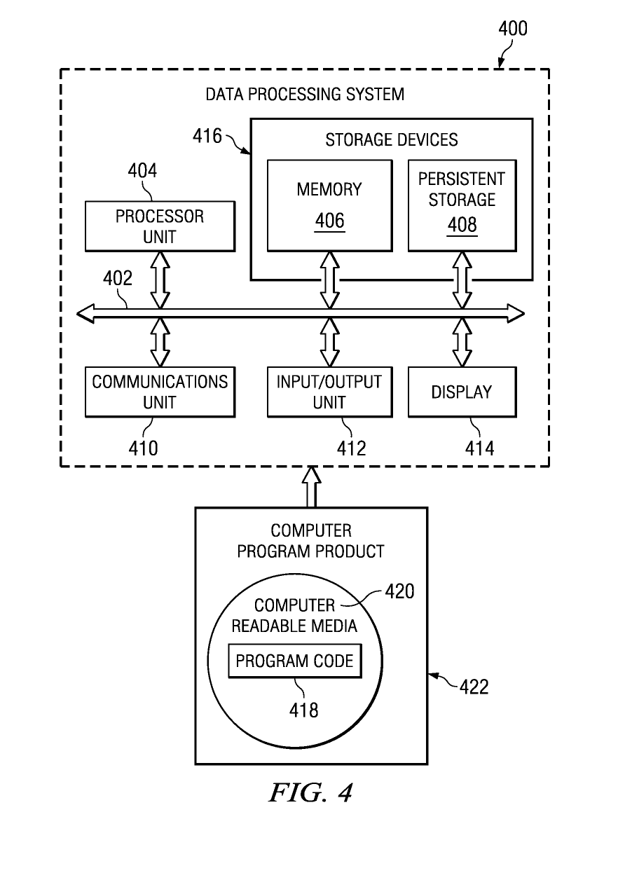

Turning now to FIG. 4, a diagram of a data processing system is depicted in accordance with an illustrative embodiment. In this illustrative example, data processing system 400 includes communications fabric 402, which provides communications between processor unit 404, memory 406, persistent storage 408, communications unit 410, input/output (I/O) unit 412, and display 414. For example, in one advantageous embodiment, display 414 may be used to implement event monitor 334 in FIG. 3. In another advantageous embodiment, display 414 may be used to display the current phase of work being executed by a workflow system, such as workflow system 300 in FIG. 3, for example.

Processor unit 404 serves to execute instructions for software that may be loaded into memory 406. Processor unit 404 may be a set of one or more processors or may be a multi-processor core, depending on the particular implementation. Further, processor unit 404 may be implemented using one or more heterogeneous processor systems in which a main processor is present with secondary processors on a single chip. As another illustrative example, processor unit 404 may be a symmetric multi-processor system containing multiple processors of the same type.

Memory 406 and persistent storage 408 are examples of storage devices 416. A storage device is any piece of hardware that is capable of storing information, such as, for example without limitation, data, program code in functional form, and/or other suitable information either on a temporary basis and/or a permanent basis. Memory 406, in these examples, may be, for example, a random access memory or any other suitable volatile or non-volatile storage device. Persistent storage 408 may take various forms depending on the particular implementation. For example, persistent storage 408 may contain one or more components or devices. For example, persistent storage 408 may be a hard drive, a flash memory, a rewritable optical disk, a rewritable magnetic tape, or some combination of the above. The media used by persistent storage 408 also may be removable. For example, a removable hard drive may be used for persistent storage 408.

Communications unit 410, in these examples, provides for communications with other data processing systems or devices. In these examples, communications unit 410 is a network interface card. Communications unit 410 may provide communications through the use of either or both physical and wireless communications links.

Input/output unit 412 allows for input and output of data with other devices that may be connected to data processing system 400. For example, input/output unit 412 may provide a connection for user input through a keyboard and mouse. Further, input/output unit 412 may send output to a printer. Display 414 provides a mechanism to display information to a user.

Instructions for the operating system, applications and/or programs may be located in storage device 416, which are in communication with processor unit 404 through communications fabric 402. In these illustrative examples the instruction are in a functional form on persistent storage 408. These instructions may be loaded into memory 406 for execution by processor unit 404. The processes of the different embodiments may be performed by processor unit 404 using computer implemented instructions, which may be located in a memory, such as memory 406.

These instructions are referred to as program code, computer usable program code, or computer readable program code that may be read and executed by a processor in processor unit 404. The program code in the different embodiments may be embodied on different physical or tangible computer readable media, such as memory 406 or persistent storage 408.

Program code 418 is located in a functional form on computer readable media 420 that is selectively removable and may be loaded onto or transferred to data processing system 400 for execution by processor unit 404. Program code 418 and computer readable media 420 form computer program product 422 in these examples. In one example, computer readable media 420 may be in a tangible form, such as, for example, an optical or magnetic disc that is inserted or placed into a drive or other device that is part of persistent storage 408 for transfer onto a storage device, such as a hard drive that is part of persistent storage 408. In a tangible form, computer readable media 420 also may take the form of a persistent storage, such as a hard drive, a thumb drive, or a flash memory that is connected to data processing system 400. The tangible form of computer readable media 420 is also referred to as computer recordable storage media. In some instances, computer readable media 420 may not be removable.

Alternatively, program code 418 may be transferred to data processing system 400 from computer readable media 420 through a communications link to communications unit 410 and/or through a connection to input/output unit 412. The communications link and/or the connection may be physical or wireless in the illustrative examples. The computer readable media also may take the form of non-tangible media, such as communications links or wireless transmissions containing the program code.

In some illustrative embodiments, program code 418 may be downloaded over a network to persistent storage 408 from another device or data processing system for use within data processing system 400. For instance, program code stored in a computer readable storage medium in a server data processing system may be downloaded over a network from the server to data processing system 400. The data processing system providing program code 418 may be a server computer, a client computer, or some other device capable of storing and transmitting program code 418.

The different components illustrated for data processing system 400 are not meant to provide architectural limitations to the manner in which different embodiments may be implemented. The different advantageous embodiments may be implemented in a data processing system including components in addition to or in place of those illustrated for data processing system 400. Other components shown in FIG. 4 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 400 is any hardware apparatus that may store data. Memory 406, persistent storage 408 and computer readable media 418 are examples of storage devices in a tangible form.

In another example, a bus system may be used to implement communications fabric 402 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 406 or a cache such as found in an interface and memory controller hub that may be present in communications fabric 402.

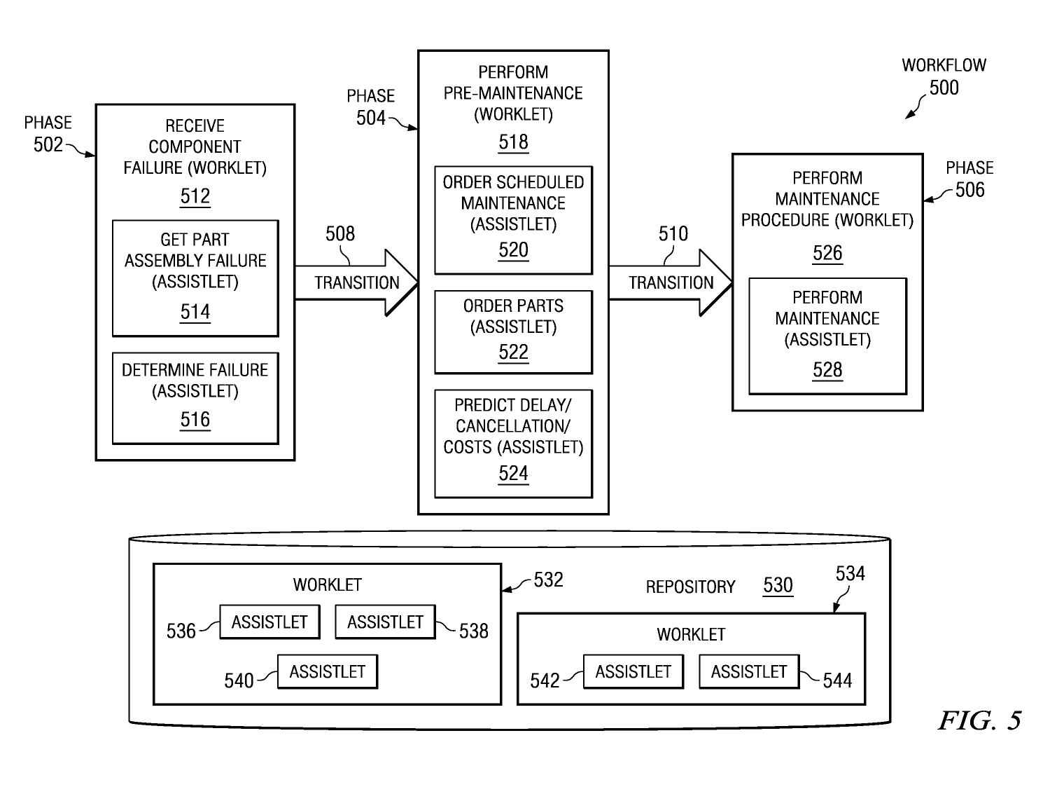

With reference now to FIG. 5, a diagram of a workflow is depicted in accordance with an advantageous embodiment. Workflow 500 is an example of one implementation of workflow 302 in FIG. 3.

Workflow 500 includes phase 502, phase 504, and phase 506. Phase 502, phase 504, and phase 506 may be an example of one implementation of number of phases 306 in FIG. 3. Phase 502 and phase 504 are connected by transition 508. Phase 504 and phase 506 are connected by transition 510. Transition 508 and transition 510 may be an example of one implementation of number of transitions 308 in FIG. 3 generated by a rule engine, such as rule engine 338 in FIG. 3, using transition logic. In this illustrative example, each phase is performed using a worklet.

Phase 502 represents receive component failure (worklet) 512. Receive component failure (worklet) 512 may include processes such as GetPartAssemblyFailure (assistlet) 514 and DetermineFailure (assistlet) 516. When the process for GetPartAssemblyFailure 514 has executed, a value may be returned. Transition 508 may represent a decision based on the value returned to stay at phase 502, which then prompts worklet 512 to execute the next process DetermineFailure 516. When DetermineFailure 516 has executed, a value may be returned that prompts transition 508 to move to the next phase 504.

Phase 504 represents perform pre-maintenance (worklet) 518. Perform pre-maintenance (worklet) 518 may include processes such as OrderScheduledMaintenance (assistlet) 520, OrderParts (assistlet) 522, and PredictDelay/Cancellation/Costs (assistlet) 524. The processes for OrderScheduledMaintenance 520, OrderParts 522, and PredictDelay/Cancellation/Costs 524 may execute and return values that prompt transition 510 to either stay in the current phase 504 or move to the next phase 506.

Phase 506 represents perform maintenance procedure (worklet) 526. Perform maintenance procedure (worklet) 526 may include a process such as PerformMaintenance (assistlet) 528. In one advantageous embodiment, the process for PerformMaintenance 528 may be performed by a human, such as a maintenance worker or maintenance crew. In this example, the maintenance worker may input a value upon completion of the process that brings workflow 500 to an end. In an illustrative example, the value may be true or false, where true indicates the service has been executed and false indicates the service has not been executed.

In one advantageous embodiment, during the execution of workflow 500, a workflow system, such as workflow system 300 in FIG. 3, may identify one or more processes that cannot execute. For example, OrderScheduledMaintenance (assistlet) 520 may be unable to execute due to that specific assistlet being unavailable during the execution of workflow 500 or due to specific resources or information being unavailable that is necessary for OrderScheduledMaintenance (assistlet) 520 to execute. The workflow system may then search repository 530, which may be an example of one implementation of repository 326 in FIG. 3, in order to identify a replacement assistlet. A replacement assistlet is a web service that can perform the same task that the original assistlet was assigned to perform, but may perform that same task using different resources. In one illustrative example, the replacement assistlet may be identified as being assigned to a different worklet and/or more than one worklet.

In an illustrative example, repository 530 may include a number of worklets, such as worklet 532 and worklet 534. Worklet 532 may include a number of web services including web services such as assistlet 536, assistlet 538, and assistlet 540. Worklet 534 may include a number of web services including web services such as assistlet 542 and assistlet 544. Assistlet 536, 538, 540, 542, and 544 may represent services that are assigned to a worklet during design-time. In this example, assistlet 542 in worklet 534 may be identified as the replacement service for OrderScheduledMaintenance (assistlet) 520 of worklet 518 in workflow 500. The workflow system may then replace OrderScheduledMaintenance (assistlet) 520 with assistlet 542, assigning assistlet 542 to perform pre-maintenance worklet 518.

In another illustrative example, OrderScheduledMaintenance (assistlet) 520, OrderParts (assistlet) 522, and PredictDelay/Cancellation/Costs (assistlet) 524 of worklet 518 may all be unavailable during run-time execution of workflow 500. In this example, the workflow system may search repository 530 for services that can replace each of assistlets 520, 522, and 524. Alternatively, the workflow system may search repository 530 for a worklet that includes a number of services that can replace each of assistlets 520, 522, and 524, such as worklet 532 for example. The search and replace function is performed by the workflow system during runtime in order to ensure that the overall project for workflow 500 moves forward.

Assistlets are not tied to a particular worklet in the repository, even if they are assigned to one or more worklets. During design-time, a user may assign assistlets to a worklet when creating a workflow model. During execution of the workflow model, the workflow system may determine that one or more of the assistlets assigned to a worklet by the user during design-time will not execute. The workflow system may then dynamically search for replacement services or assistlets, and replace the services or assistlets during run-time with a more appropriate service or assistlet that will execute.

The illustration of workflow 500 in FIG. 5 is not meant to imply physical or architectural limitations to the manner in which different advantageous embodiments may be implemented. Other components in addition and/or in place of the ones illustrated may be used. Some components may be unnecessary in some advantageous embodiments. Also, the blocks are presented to illustrate some functional components. One or more of these blocks may be combined and/or divided into different blocks when implemented in different advantageous embodiments.

For example, in some advantageous embodiments, workflow 500 may include any number of phases. As used herein, number refers to one or more phase. In another example, each phase may have any number of processes.

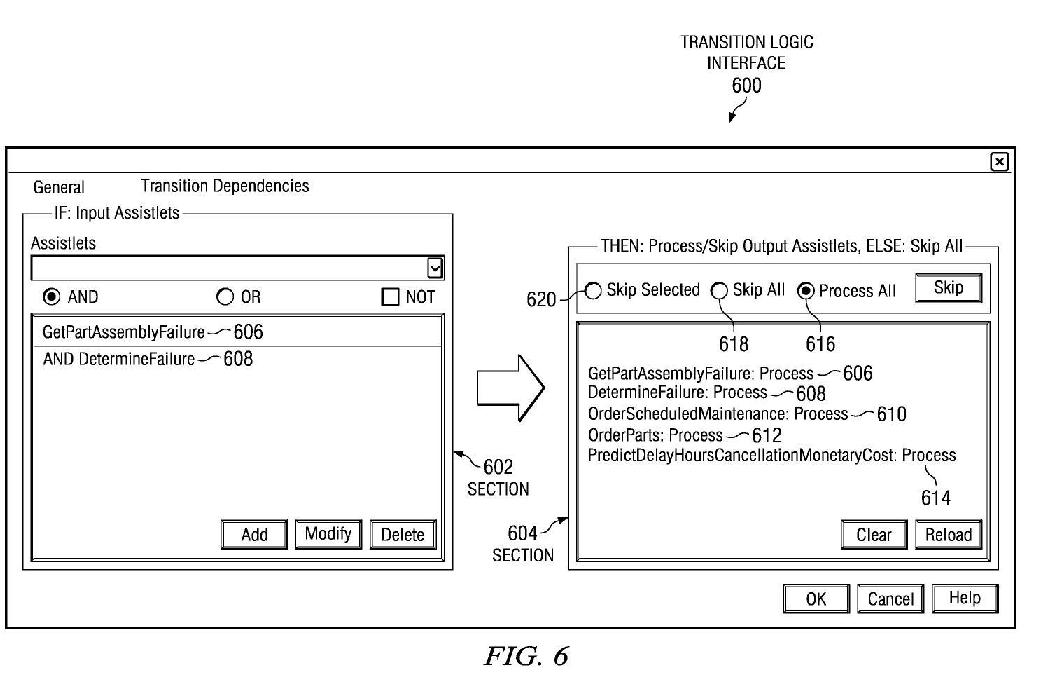

With reference now to FIG. 6, a diagram of a transition logic interface is depicted in accordance with an advantageous embodiment. Transition logic interface 600 may be an example of one implementation of transition logic interface 326 in FIG. 3.

Transition logic interface 600 is a graphical user interface that enables users to map services, or assistlets for example, to existing worklets. Transition logic interface 600 displays transition logic, such as transition logic 327 in FIG. 3 for example. Transition logic may be stored remotely from transition logic interface 600, such as in repository 326 in FIG. 3, or may be stored locally at transition logic interface 600.

Transition logic represents each web service, or assistlet, as a proposition. Transition logic interface 600 displays the propositions as associations of one set of web services, or assistlets, to another set of web services based on either the return value for each web service or external rules. These propositions may appear in IF section 602 and/or THEN section 604 of transition logic interface 600. Web services, or assistlets, represented by a proposition in the IF section 602 may be associated to the web services, or assislets, represented by a proposition in the THEN section 604. For example, GetPartAssemblyFailure 606 AND DetermineFailure 608 in IF section 602 may be associated with a number of web services in THEN section 604, such as, for example, OrderScheduledMaintenance 610, OrderParts 612, and/or PredictDelayHoursCancellationMonetaryCost 614. This association allows the web services or assistlets assigned to the next phase, or worklet, to be either executed, partially executed, or skipped.

An association may be selected in THEN section 604, such as process all 616, skip all 618, or skip selected 620. The association may be selected by a user or by external rules. Selecting process all 616 may result in executing all assistlets in the selected worklet. Selecting skip all 618 may result in none of the assistlets in the selected worklet being executed. Selecting skip selected 620 may result in the assistlets in the selected worklet being partially executed.

This adaptation provides for modeling of very complex control flows with a number of possible exceptions. Adaptations that can be anticipated during design-time can be supported automatically.

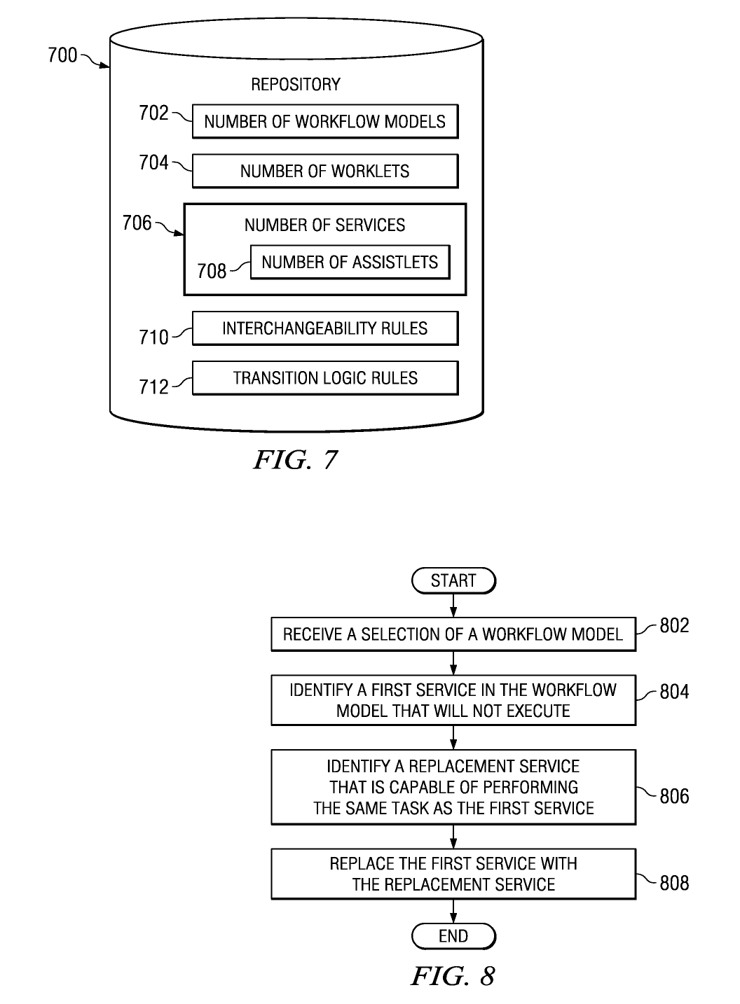

With reference now to FIG. 7, a diagram of a repository is depicted in accordance with an advantageous embodiment. Repository 700 may be an example of one implementation of repository 332 in FIG. 3.

Repository 700 includes number of workflow models 702. Number of workflow models 702 may include, for example, without limitation, prior workflow models, currently employed workflow models, anticipated workflow models, unexecuted workflow models, and/or any other workflow model capable of being used in a workflow environment.

Repository 700 may include number of worklets 704 and number of services 706. Number of worklets 704 is a collection of worklets that are capable of performing a number of phases of work. Number of services 706 are a collection of services that are each capable of performing a specific task within a phase of work. Number of services 706 may include number of assistlets 708. Number of assistlets 708 is a collection of web services that are executable program components for performing a specific element of a task. One or more services from number of services 706 may be assigned to one or more worklets from number of worklets 704. Number of workflow models 702 may contain any number of different workflow models made up of one or more worklets from number of worklets 704 and one or more services from number of services 706.

Repository 700 may also include interchangeability rules 710 and transition logic rules 712. Interchangeability rules 710 contains information about the number of different services, or assistlets, that are capable of performing the same, or similar, executable step in a phase of work.

Transition logic rules 712 contains information about how transitions between phases of work operate and decision results for a number of values that may be returned by number of services 706.

Repository 700 may be used during design time to retrieve the most appropriate worklet or assistlet for a workflow model available at design time. Repository 700 may be searched during runtime by a workflow engine, such as workflow engine 328 in FIG. 3, to autonomously retrieve a more appropriate worklet or assistlet during execution of the workflow model. Repository 700 may also manage the state of the individual services, or assistlets, during runtime. Related messages and events that reflect the runtime status of individual services and assistlets, possibly coming from event monitors, are persistently stored in the repository.

With reference now to FIG. 8, a flowchart illustrating a process for adaptive workflow management is depicted in accordance with an advantageous embodiment. The process in FIG. 8 may be implemented by a component such as workflow engine 328 in FIG. 3, for example.

The process begins by receiving a selection of a workflow model (operation 802). The workflow model may be selected by a user from a repository, such as repository 326 in FIG. 3. Alternatively, the process may receive a selection of a newly created workflow model from a user. For example, a user may create a workflow model during design process 320 in FIG. 3, and select that workflow model to be executed in a runtime environment. The process next identifies a first service in the workflow model that will not execute (operation 804). The first service that will not execute may be, for example, an assistlet, such as assislet 318 in FIG. 3. The first service, or assistlet, that will not execute may be a service that was initially assigned to a worklet in the workflow model during design-time, for example. The worklet in the workflow model that includes the first service that will not execute may be, for example, a worklet, such as worklet 314 in FIG. 3. In an illustrative example, the first service that will not execute may not be able to execute due to a lack of information availability or some other suitable reason for failure to execute. The first service that will not execute may be assigned to a specific task or element for the phase of work to which it is assigned.

Next, the process identifies a replacement service that is capable of performing the same task as the first service that will not execute (operation 806). The replacement service may be associated with a different worklet than the worklet to which the first service is assigned in the currently executing workflow model. The replacement service may be identified by searching a repository of services, such repository 326 in FIG. 3, for example. A replacement service is a service that can perform the same task that the original service was assigned to perform, but may perform that same task using different resources.

The process replaces the first service with the replacement service (operation 808), with the process terminating thereafter. This replacement, or adaptation, of the workflow model may occur during runtime.

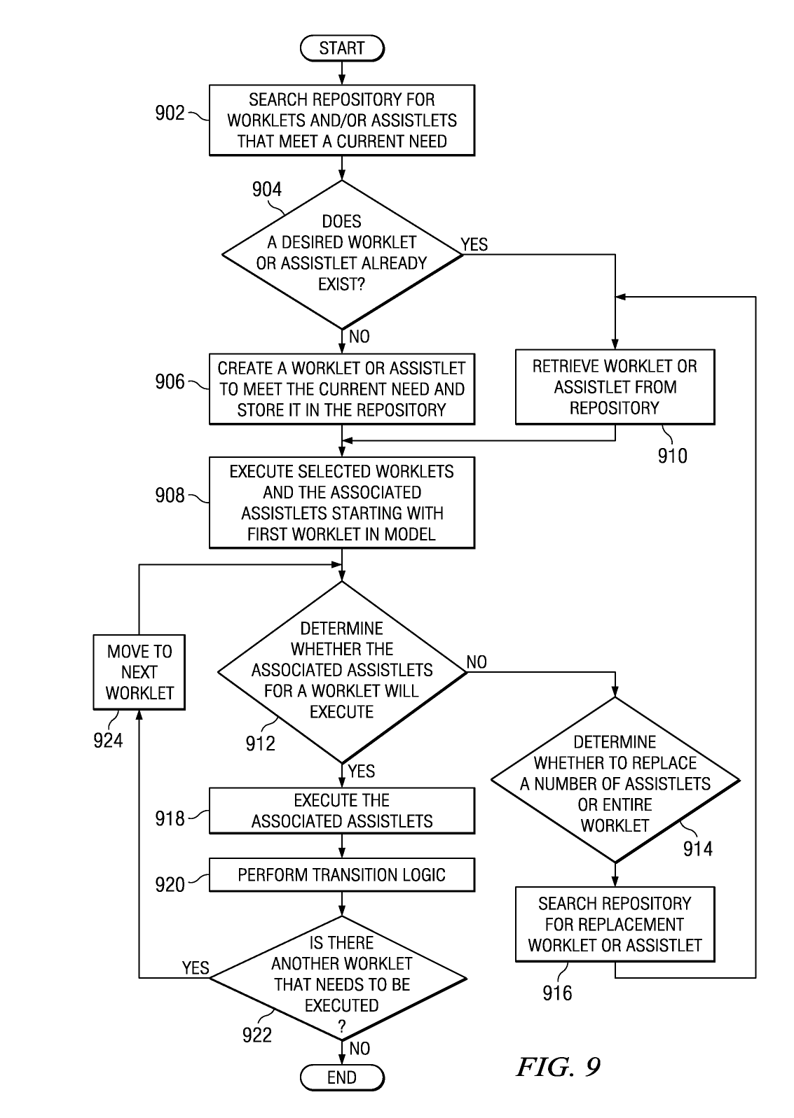

With reference now to FIG. 9, a flowchart illustrating a process for automated workflow modeling is depicted in accordance with an advantageous embodiment. The process in FIG. 9 may be implemented by a component such as workflow engine 328 in FIG. 3, for example.

The process begins by searching the repository for worklets and/or assistlets that meet a current need (operation 902). The repository may be, for example, repository 326 in FIG. 3. In one advantageous embodiment, a user may search the repository for worklets and/or assistlest that meet a current need of the user for developing a workflow model. The user may select the worklets and/or assistlets that are appropriate for the model in regards to a determination made during design-time modeling.

The process then determines whether a desired worklet or assislet already exists (operation 904). A desired worklet or assistlet may be a worklet or assistlet that is identified as meeting the current need for the workflow model. A determination as to whether a worklet or assistlet exists can be made by searching the repository of existing worklets and assistlet. If a determination is made that the desired worklet or assistlet does not exist, the process creates a worklet and/or assistlets to meet the current need and stores the newly created worklet and/or assistlets in the repository (operation 906).

The process then executes the selected worklets and their associated assistlets starting with the first worklet in the model (operation 908). The process may execute the selected worklets and associated assistlets using a workflow system, such as workflow system 300 in FIG. 3, for example. The steps illustrated in operation 908 and on may be executed autonomously by a workflow system.

If a determination is made that the desired worklet or assislet does exist, the process retrieves the worklet and/or assistlet from the repository (operation 910). The process then moves to operation 908.

During execution of the selected worklets and their associated assistlets, the process determines whether the associated assistlets for a worklet will execute (operation 912). Assistlets may or may not execute based on a number of factors, such as, for example, without limitation, availability of a required resource and/or information. If a determination is made that one or more of the associated assistlets for a worklet will not execute, the process next determines whether to replace a number of assistlets associated with the worklet or replace the entire worklet (operation 914). The process then searches the repository for replacement assistlets or a replacement worklet (operation 916) and returns to operation 910.

If a determination is made that the associated assistlets for a worklet will execute, the process then executes the associated assistlets (operation 918). The process then performs transition logic (operation 920) and determines whether there is another worklet in the model that needs to be executed (operation 922). If a determination is made that there is another worklet that needs to be executed, the process moves to the next worklet (operation 924) in the workflow model, and returns to operation 912. If a determination is made that there is not another worklet that needs to be executed in the workflow model, the process terminates.

The different advantageous embodiments recognize and take into account that currently used systems for service orchestration do not offer sufficient flexibility for adaptability. Mapping high level process models to low level services or processes is not a simple task and it is dependent upon how the individual low level processes are described. Additionally, it is not always possible to predict in advance all of the parameters that may be important for the high level process. It may not be possible to specify all the process details associated with a complex process at the outset. The initial workflow model may represent a high level view of the process, which includes some of the sub-processes. Gradually, some of these sub-processes may be refined as the stakeholders obtain more experience and knowledge of a particular process. A change may also impose a new requirement that impacts the process definition.

The different advantageous embodiments further recognize that relevant information to a process may only be determined during runtime. Current methods require an estimation of the structure of the process in the context of a specific environment. This estimation depends upon when information will be available and the way or circumstances in which information can be gathered.

Thus, the different advantageous embodiments provide a method, apparatus, and computer program product for improved workflow management. A first workflow model is selected from a number of workflow models. The first workflow model may include a number of Worklets and the number of Worklets may include a number of services. A first service in the number of services is identified that will not execute. The first service is capable of performing a first task. A second service is identified that is capable of performing the first task. The first service in the first workflow model is replaced with the second service.

The different advantageous embodiments provide a simpler but more adaptive way to compose services and allows for modeling at a high level view of the process with dynamic instantiation of process details at runtime. The different advantageous embodiments provide design time flexibility and runtime adaptability. The different advantageous embodiments greatly simplify modeling efforts and separate business rules from business models that enable process agility.

The different advantageous embodiments can take the form of an entirely hardware embodiment, an entirely software embodiment, or an embodiment containing both hardware and software elements. Some embodiments are implemented in software, which includes but is not limited to forms, such as, for example, firmware, resident software, and microcode.

Furthermore, the different embodiments can take the form of a computer program product accessible from a computer-usable or computer-readable medium providing program code for use by or in connection with a computer or any device or system that executes instructions. For the purposes of this disclosure, a computer-usable or computer readable medium can generally be any tangible apparatus that can contain, store, communicate, propagate, or transport the program for use by or in connection with the instruction execution system, apparatus, or device.

The computer usable or computer readable medium can be, for example, without limitation an electronic, magnetic, optical, electromagnetic, infrared, or semiconductor system, or a propagation medium. Non limiting examples of a computer-readable medium include a semiconductor or solid state memory, magnetic tape, a removable computer diskette, a random access memory (RAM), a read-only memory (ROM), a rigid magnetic disk, and an optical disk. Optical disks may include compact disk-read only memory (CD-ROM), compact disk-read/write (CD-R/W) and DVD.

Further, a computer-usable or computer-readable medium may contain or store a computer readable or usable program code such that when the computer readable or usable program code is executed on a computer, the execution of this computer readable or usable program code causes the computer to transmit another computer readable or usable program code over a communications link. This communications link may use a medium that is, for example without limitation, physical or wireless.

A data processing system suitable for storing and/or executing computer readable or computer usable program code will include one or more processors coupled directly or indirectly to memory elements through a communications fabric, such as a system bus. The memory elements may include local memory employed during actual execution of the program code, bulk storage, and cache memories which provide temporary storage of at least some computer readable or computer usable program code to reduce the number of times code may be retrieved from bulk storage during execution of the code.

Input/output or I/O devices can be coupled to the system either directly or through intervening I/O controllers. These devices may include, for example, without limitation to keyboards, touch screen displays, and pointing devices. Different communications adapters may also be coupled to the system to enable the data processing system to become coupled to other data processing systems or remote printers or storage devices through intervening private or public networks. Non-limiting examples are modems and network adapters are just a few of the currently available types of communications adapters.

The description of the different advantageous embodiments has been presented for purposes of illustration and description, and is not intended to be exhaustive or limited to the embodiments in the form disclosed. Many modifications and variations will be apparent to those of ordinary skill in the art. For example, although the different advantageous embodiments have been described with respect to aircraft, other advantageous embodiments may be applied to other types of objects. For example, without limitation, other advantageous embodiments may be applied to a mobile platform, a stationary platform, a land-based structure, an aquatic-based structure, a space-based structure and/or some other suitable object. More specifically, the different advantageous embodiments may be applied to, for example, without limitation, a submarine, a bus, a personnel carrier, tank, a train, an automobile, a spacecraft, a space station, a satellite, a surface ship, a power plant, a dam, a manufacturing facility, a building and/or some other suitable object.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for workflow management, the method comprising:
receiving a selection of a first workflow model from a number of workflow models, wherein the first workflow model includes a number of worklets, and wherein each worklet in the number of worklets includes a number of services;
identifying a first service in the number of services that does not execute using a processing unit, wherein the first service is capable of performing a first task;
identifying a second service that is capable of performing the first task using the processing unit; and
replacing the first service in the first workflow model with the second service using the processing unit.

2. The method of claim 1, wherein the number of workflow models are stored in a repository.

3. The method of claim 1, wherein replacing the first service with the second service further comprises:
identifying interchangeability rules for each service in the number of services.

4. The method of claim 1, further comprising:
executing the second service in the first workflow model;
receiving a return value associated with the execution of the second service; and
responsive to receiving the return value, determining whether the first workflow model will stay in the current worklet or proceed to a next worklet.

5. The method of claim 1, further comprising:
executing the first workflow model; and
displaying output based on the execution of the first workflow model on a display device.

6. The method of claim 5, further comprising:
executing a process based on the output displayed on the display device.

7. A method for workflow management, the method comprising:
executing a workflow model, wherein the workflow model includes a number of worklets and each worklet in the number of worklets has a number of associated assistlets;
determining whether a number of associated assistlets for a first worklet in the number of worklets execute during execution of the workflow model;
responsive to a determination that the number of associated assistlets for the first worklet execute, executing the number of associated assistlets for the first worklet.

8. The method of claim 7, further comprising:
responsive to a determination that the number of associated assistlets for the first worklet do not execute, determining whether to replace the number of associated assistlets for the first worklet or the first worklet.

9. The method of claim 8, further comprising:
responsive to a determination to replace the number of associated assistlets for the first worklet, searching a repository for a number of replacement assistlets for the first worklet;
retrieving the number of replacement assistlets from the repository; and
executing the number of replacement assistlets for the first worklet.

10. The method of claim 8, further comprising:
responsive to a determination to replace the first worklet, searching a repository for a replacement worklet for the first worklet;
retrieving the replacement worklet from the repository; and
executing the replacement worklet in place of the first worklet.

11. The method of claim 7, further comprising:
performing transition logic, wherein the transition logic represents associations between the number of associated assistlets, and wherein the association may result in at least one of executing all of the number of associated assistlets, partially executing the number of associated assistlets, and executing none of the number of associated assistlets.

12. The method of claim 7, further comprising:
determining whether a second worklet needs to be executed; and
responsive to a determination that the second worklet needs to be executed, determining whether a number of associated assistlets for the second worklet execute during execution of the workflow model.

13. The method of claim 12, further comprising:
responsive to a determination that the number of associated assistlets for the second worklet do not execute, determining whether to replace the number of associated assistlets for the second worklet or the second worklet.

14. The method of claim 7, further comprising:
responsive to a determination to replace the number of associated assistlets for the second worklet, searching a repository for a number of replacement assistlets for the second worklet;
retrieving the number of replacement assistlets from the repository; and
executing the number of replacement assistlets for the second worklet.

15. The method of claim 13, further comprising:
responsive to a determination to replace the second worklet, searching a repository for a replacement worklet for the second worklet;
retrieving the replacement worklet from the repository; and
executing the replacement worklet in place of the second worklet.

16. The method of claim 7, further comprising:
performing a task using the workflow model, wherein the task is part of a process.

17. The method of claim 16, wherein the process is selected from at least one of aircraft maintenance, aircraft assembly, aircraft service, and aircraft manufacturing.

18. An apparatus comprising:
a processing unit;
a rule engine capable of being executed on the processing unit; and
a workflow engine capable of being executed on the processing unit, wherein the workflow engine executes a workflow system to execute a workflow model, wherein the workflow model includes a number of worklets, and wherein each worklet in the number of worklets has a number of associated assistlets; determine whether a number of associated assistlets for a first worklet in the number of worklets execute during execution of the workflow model; and responsive to a determination that the number of associated assistlets for the first worklet execute, execute the number of associated assistlets for the first worklet.

19. The apparatus of claim 18, wherein the workflow engine further executes the workflow system to:
responsive to a determination that the number of associated assistlets for the first worklet do not execute, determine whether to replace the number of associated assistlets for the first worklet or the first worklet.

20. The apparatus of claim 19, wherein the workflow engine further executes the workflow system to:
responsive to a determination to replace the number of associated assistlets for the first worklet, search a repository for a number of replacement assistlets for the first worklet;
retrieve the number of replacement assistlets from the repository; and
execute the number of replacement assistlets for the first worklet.

21. The apparatus of claim 19, wherein the workflow engine further executes the workflow system to:
responsive to a determination to replace the first worklet, search a repository for a replacement worklet for the first worklet;
retrieve the replacement worklet from the repository; and
execute the replacement worklet in place of the first worklet.

22. The apparatus of claim 18, wherein the workflow engine further executes the workflow system to:
perform transition logic, wherein the transition logic represents associations between the number of associated assistlets, and wherein the association may result in at least one of executing all of the number of associated assistlets, partially executing the number of associated assistlets, and executing none of the number of associated assistlets.

23. The apparatus of claim 18, wherein the workflow engine further executes the workflow system to:
determine whether a second worklet needs to be executed; and
responsive to a determination that the second worklet needs to be executed, determine whether a number of associated assistlets for the second worklet execute during execution of the workflow model.

24. The apparatus of claim 23, wherein the workflow engine further executes the workflow system to:
responsive to a determination that the number of associated assistlets for the second worklet do not execute, determine whether to replace the number of associated assistlets for the second worklet or the second worklet.

25. The apparatus of claim 24, wherein the workflow engine further executes the workflow system to:
responsive to a determination to replace the number of associated assistlets for the second worklet, search a repository for a number of replacement assistlets for the second worklet;
retrieve the number of replacement assistlets from the repository; and
execute the number of replacement assistlets for the second worklet.

26. The apparatus of claim 24, wherein the workflow engine further executes the workflow system to:
responsive to a determination to replace the second worklet, search a repository for a replacement worklet for the second worklet;
retrieve the replacement worklet from the repository; and
execute the replacement worklet in place of the second worklet.
